(19) United States
(12) Patent Application Publication
(10) Pub. No.: US 2006/0236662 A1
(43) Pub. Date: Oct. 26, 2006

(54) Deflection chamber for eliminating water in a fresh air supply system of a motor vehicle

(75) Inventors: Joachim Currle, Stuttgart (DE); Frank Fruehauf, Aichwald (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 10/562,232

(22) PCT Filed: Jun. 15, 2004
(86) PCT No.: PCT/EP04/06408

§ 371 Date: May 31, 2006

(30) Foreign Application Priority Data
Jun. 26, 2003 (DE) 103 28 671.3

(51) Int. Cl. B01D 50/00

(52) U.S. Cl. 55/315

(57) ABSTRACT

Disclosed is a deflection chamber (1) for eliminating water in a fresh air supply system of a motor vehicle, comprising an inlet port (2) located at the top in the mounted state, an outlet port (3) that is arranged essentially at a right angle therefrom, and a drainage bottom (4) which is placed below the inlet port in the mounted state and collects and drains away water. In order to prevent drops of water, which are separated from the air, from bursting and mist from forming in said deflection chamber (1), the steeply rising lamellae of the deflection chamber are disposed in such a way that the lamellae (5-9) are aligned at an acute angle from the direction of arrival (A) of the drops of water in the free craoss section between the inlet port (2) and the drainage bottom (4) while fully covering the drainage bottom (4) in the direction of arrival (A).

### BACKGROUND AND SUMMARY OF THE INVENTION

The present invention relates to a deflection chamber for eliminating water in a fresh air supply system of a motor vehicle.

German document DE 199 23 195 C1 concerns a deflection chamber of a fresh air supply system which eliminates the liquid water from a fresh air supply carrying water droplets. The fresh air makes its way into the deflection chamber via, in the mounted state, an upper inlet and is deflected in the direction of the lateral outlet port. As a result of the change of direction of the air current and its inertia, the water droplets, aided by the action of gravitational force, are separated from the air current and collide in the region of the water drainage walls, which, in the mounted state, are situated below the inlet port, with the housing bottom present there. The water is collected on the housing bottom and the surrounding housing walls of the deflection chamber and passes out from the housing of the deflection chamber, in the mounted state, at a lower drainage port. In order to reduce air flow velocities in the region of the water drain, lamellae, which stand vertically in the mounted state, are disposed above the water drainage bottom. The water droplets of the fresh air fall into the interspace between the lamellae and may burst as a result of colliding with the water drainage bottom. A mist of minute water droplets is in this case formed, which can make its way back into the air flow and be carried along by it.

The object of the invention is to provide a compact deflection chamber which eliminates water droplets from the air flow without these bursting upon impact with floor or walls.

The object is achieved by the claimed invention.

In the deflection chamber trapping elements are provided, which form steeply sloping walls against whose surface the droplets impact at an acute angle and can run off. As a result of the acute angle of impact upon the surface of the trapping elements, the droplets are prevented from bursting. The trapping elements can be configured as lamellae which are arranged side by side and which, in the region of the edges, mutually overlap in the direction of arrival. For the collection and evacuation of the trapped water, a drainage wall or a plurality of drainage walls is provided. The flat regions of the drainage wall(s), disposed below or behind the trapping elements, is fully covered by the lamellae. Incoming water droplets cannot therefore strike the flat drainage walls, but run off on the trapping elements without bursting.

The basic concept of the invention lies in not allowing the water droplets which have made their way through the inlet port into the deflection chamber to impact upon a wall directed transversely to their motion, but rather to design the deflection chamber such that the water droplets strike a wall at an acute angle. In this case, when the water droplet impacts, the momentum necessary for bursting is lacking, with the result that it instead wets the wall and runs down it. Ideally, impact angles, i.e. the angle between droplet path and impact surface, of more than 40° should be avoided.

The design of the deflection chamber relates with its geometry to the direction of arrival of the water droplets in the inlet port and, in addition, also to the direction of outflow of the air through the outlet port. By these directions of arrival and outflow are meant principal directions of the falling water droplets and of the air current, which does not preclude the flow directions from differing therefrom in marginal regions or close to upstream or downstream flow-guiding components. Furthermore, the direction of inflow of the air current passing through the inlet port can differ from the direction of arrival of the water droplets in this region.

One embodiment of the deflection chamber has a high-level inlet port, which is facing, for example, an engine-hood grille or a suction port behind the hood. The outlet port is disposed in a side wall of the deflection chamber and delivers the air, for example, to the suction tract of the vehicle cab. In this case, the water droplets particularly strike drainage walls disposed opposite the inlet port and in the region below it. In this embodiment, the air current is deflected in the sum of the deflection angles by at least 90°, whereby a particularly effective water elimination is possible. The precise position and siting of the elements, however, is generally restricted by construction space dictates or is predefined. Thus, the direction of inflow of the air may also be directed broadly horizontally and the deflection of the air current may also amount to more than 180°.

One particular embodiment of the deflection chamber has lamellae as trapping elements. By lamellae are here meant broadly free-standing, wall-like fixtures, which can be configured integrally with the housing of the deflection chamber, as single parts or, indeed, in the form of a grille. The lamellae are a very simple realization of the trapping elements.

In order to prevent water droplets which fall at an oblique angle to the direction of arrival from falling through the gap between two lamellae down to the flat drainage bottom, the lamellae are made bent or curved along the direction of arrival, i.e. along their height. They thus have an angle to the direction of arrival which varies across the height and form an undercut which can cover the drainage bottom in the free gap cross section of their upper end in all directions. In this embodiment, the upper region of the lamella can also be aligned in the direction of arrival and can form the acute angle to the direction of arrival somewhat lower down.

In order to obtain a very compact construction, the trapping elements can be realized as wedge profiles. The lower ends of mutually adjoining wedge profiles can in this case be connected and form drainage channels.

In a compact construction, particularly in terms of the structural height, two grilles of approximately parallel-standing trapping elements, which grilles are disposed in mutually offset arrangement one above the other and transversely to the longitudinal extent of the lamellae or wedge profiles, manage to prevent any water droplets from striking the drainage bottom between the lower lamellae or wedge profiles.

In one embodiment of the fresh air supply system, the lamellae are aligned essentially transversely to the direction of discharge from the chamber. The air current thus sweeps transversely over the top edges of the lamellae, the lamellae being able to be obliquely angled in the direction of the outlet port or, indeed, in the opposite direction away from the outlet port. The arrangement of the lamellae transversely to the discharge allows a particularly high level of water elimination, which is somewhat lower if the lamellae are tilted toward the outlet port under a minor drop in pressure, and is higher if the lamellae are tilted away from the outlet direction.

In a further embodiment, in order to reduce the drop in pressure in the flowed-through deflection chamber, the lamellae are arranged at least with their upper margin in the direction of discharge. The lamellae can thus jut into the air flow or even be extended as far as the inlet port.

In order to prevent water droplets from being entrained on those edges of the lamellae which are directed toward the outlet port, in one embodiment of the fresh air suction device drainage ribs, on which the water runs off obliquely downward, are disposed on the walls of the lamellae.

Further advantageous embodiments of the invention emerge from the drawings and the description thereof.

### BRIEF DESCRIPTION OF THE DRAWINGS

FIG. 1 is a sectional representation of the deflection chamber through the inlet and outlet port,

FIG. 2 is a sectional representation, similar to FIG. 1, with curved lamellae in the deflection chamber,

FIG. 3 is a sectional representation, similar to FIG. 1, with lamellae arranged into wedge profiles,

FIG. 4 is a sectional representation, transversely to the section of FIG. 1, through the inlet port with direction of view onto the outlet port, with lamellae along the direction of outflow, and

FIG. 5 is a sectional representation, similar to FIG. 1, with lamellae along the direction of outflow.

### DETAILED DESCRIPTION OF THE INVENTION

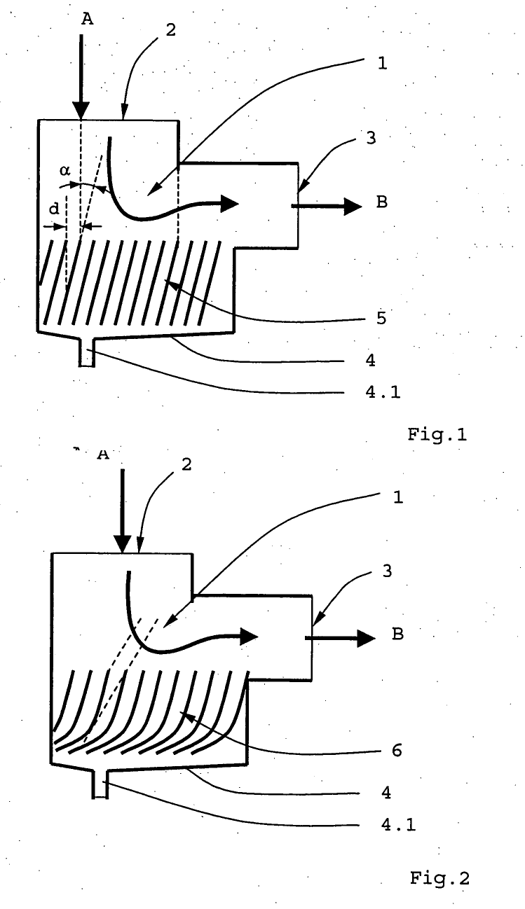

In FIG. 1, an inventive deflection chamber 1 of a fresh air supply system of a motor vehicle is shown in a sectional representation. The section runs approximately in the middle of an inlet port 2 and an outlet port 3, roughly parallel to a direction of arrival A of the water droplets falling through the inlet port 2 and to the direction of outflow B of the air current passing through the outlet port 3. A direction of inflow of an air current passing through the inlet port can differ from the direction of arrival A of the water droplets.

The deflection chamber 1 is represented in its mounted state, the direction of arrival A being realized essentially vertically downward and a direction of outflow B being realized horizontally essentially at a right angle thereto. Correspondingly, the inlet port 2 is disposed, in the mounted state, high up on the deflection chamber in horizontal alignment, and the outlet port 3 on the side of the deflection chamber in broadly vertical alignment. In the mounted state, low down in the deflection chamber relative to the inlet port 2, a drainage bottom 4 is provided, which is flatly configured and is disposed broadly at a right angle to the direction of arrival A. In the drainage bottom 4, a drainage port 4.1 is provided. Above the drainage bottom 4 in the mounted state, lamellae 5 are disposed in the deflection chamber as trapping elements. The lamellae 5 are aligned at an angle a to the direction of arrival A and have a spacing d transversely to the direction of arrival A. The angle a is in this case an acute angle of less than 40°. The extent of each individual lamella transversely to the direction of arrival A, which is derived from the angle a and the height of the lamella, is greater than the spacing d, so that adjacent lamellae overlap one another in the direction of arrival A. Furthermore, the lamellae 5 cover the whole of the drainage bottom 4 below the inlet port 2 in the direction of arrival A. The lateral boundary of this region in the direction of the outlet port is marked by a broken line.

The lamellae 5 run in terms of their width at a right angle to the sectional plane of the drawing. The deflected air flow thus sweeps transversely over the top edges of the lamellae 5. As a result of the alignment transversely to the air current, only very small flows develop between the lamellae. The obstruction by the lamellae, however, calls for the formation of a flow clearance above the lamellae 5, which flow clearance is shaped according to the pressure drop requirements of the deflection chamber. The eliminated water thus runs off downward on the lamellae 5 by gravitational force, without hindrance. The lamellae 5 are angled obliquely toward the outlet port 3, with the result that the air sweeps over the lamellae 5 with less resistance.

In the illustrated deflection chamber 1, an air flow laden with water droplets enters, in the mounted state, essentially in the vertical direction, i.e. parallel to the direction of arrival A at the inlet port 2. If an inlet grille equipped with lamellae, or a feed duct, for example, is disposed upstream of the inlet port, the direction of inflow of the air may also differ from the vertical direction. The water droplets transported by the air fall in the direction of arrival A into the deflection chamber. As a result of the drainage bottom 4 and the above-situated lamellae 5, the air current is deflected out of the vertical direction into a horizontal direction toward the lateral outlet port 3 and escapes there in the outlet direction B. The water droplets, by virtue of their inertia and with the aid of gravitational force, are separated from the air flow when this is deflected and strike the lamellae 5 in the direction of arrival A. The lamellae 5 are disposed at an acute angle α to this direction. As a result of the acute impact angle, the water droplet runs, without bursting, along the wall of the lamella to the lower edge and drips down from there onto the drainage bottom 4.

FIG. 2 shows the deflection chamber 1 in the same construction and in the same arrangement of inlet port 2, outlet port 3, drainage bottom 4, drainage port 4.1 and arrangement of the lamellae over the drainage bottom as in FIG. 1. Similarly, the direction of arrival A of the water droplets and the direction of outflow B of the air current correspond to FIG. 1. The lamellae 6 of the deflection chamber which are shown here are curved along their height. The broken lines indicate that, through the curvature of the lamellae 6, the drainage bottom of the deflection chamber is fully concealed by the walls of the lamellae 6, not only in the direction of arrival of the water droplets but also in line with the free shaft situated between the lamellae. In addition, the lamellae 6 are more closely spaced at their foot, i.e. close to the drainage bottom, than at the edge facing the inlet port. Consequently, a flow passage through the free cross section between and below the lamellae 6 is reduced and the run-off of the water on the lamellae 6 and the drainage bottom is improved.

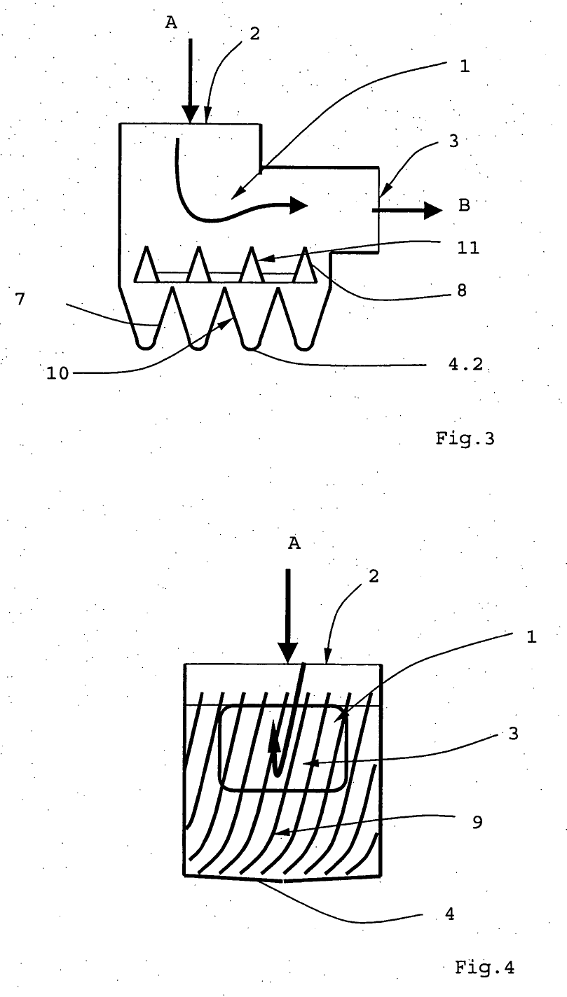

FIG. 3 shows the deflection chamber 1, which, in the arrangement of inlet port, outlet port, direction of arrival A of the water droplets, direction of outflow B of the air current and arrangement of the lamellae over the drainage bottom, corresponds to FIG. 1. In this embodiment, wedge profiles 7 and 8 are provided as trapping elements. The wedge profiles 7 and 8 respectively have collecting walls disposed at acute angles opposite to the direction of arrival A. Transversely to the extent of the wedge profile 7, there are disposed, in the mounted state, laterally offset, parallel wedge profiles belonging to a grille 10. In the lower region in the mounted state, the mutually adjacent wedge profiles of the grille 10 are respectively connected to form drainage channels 4.2, so that no separate drainage bottom is necessary. The water is drained, furthermore, by means of a collecting duct (not further represented) and a drainage port or through individual drainage ports.

Above the grille 10 in the mounted state, there are disposed parallel to the wedge profiles of the grille 10 further wedge profiles 8 belonging to a grille 11. The parallel wedge profiles of the grille 11 are distanced apart in the lower region. The wedge profiles of the grille 10 and those of the grille 11 are aligned parallel to each other and have the same distance one to another. Furthermore, the grille 11 is offset by half a spacing relative to the underlying grille 10 in the mounted state, so that the wedge profiles of the grille 11 cover the drainage channels 4.2 between the wedge profiles of the grille 10 in the direction of arrival A. The two grilles 10 and 11, placed one above the other in mutually offset arrangement and made up of parallel lamellae connected to form wedge profiles, allow the drainage bottom and the corresponding drainage channels 4.2 to be covered, in the direction of arrival A, over the whole of the area below the inlet port 2, with the result that water droplets can strike oblique walls of the lamellae only at an acute angle.

FIG. 4 shows a sectional representation through an embodiment of the deflection chamber 1, transversely to the sectional plane of FIGS. 1-3. The sectional plane of FIG. 4 extends through the inlet port with direction of view in the outlet direction B of FIGS. 1-3. The deflection chamber 1 is represented once again in the mounted state. In the upper region, it has the inlet port 2, through which the fresh air makes its way into the deflection chamber 1 in an approximately vertical direction of inflow. Disposed in the chamber are lamellae 9, which extend in terms of their width in the direction of view, i.e. in the direction of outflow B. The air flows through the free cross section between the lamellae 9 and along the walls of the lamellae 9. The lamellae 9 are arranged side by side in parallel, running obliquely downward at an acute angle to the direction of arrival A and, in the direction of arrival A, conceal the drainage bottom 4. The water droplets which have made their way through the inlet port 2 with the inflowing air into the deflection chamber travel in the direction of arrival A upon entering the deflection chamber. The inflowing air is deflected out of the downwardly directed motion predominantly by the drainage bottom 4, in the direction of view of the representation, to the outlet port 3 which is present there. In their downwardly directed motion, the water droplets strike the lamellae 9 disposed obliquely at an acute angle and run on these downward to the drainage bottom 4.

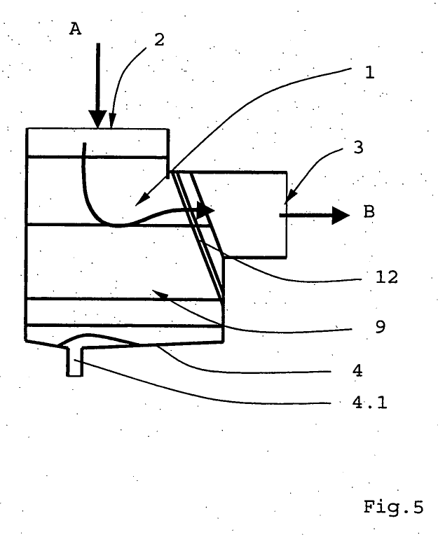

FIG. 5 shows the embodiment of the deflection chamber 1 shown in FIG. 4, in a section in accordance with FIG. 1. The arrangement of inlet port 2, outlet port 3, drainage bottom 4, drainage port 4.1, direction of arrival A and direction of outflow B correspond to those of FIG. 1. In the representation of this embodiment, the lamellae 9 disposed in the deflection chamber 1 can be seen in a lateral top view. As a result of the vertical alignment of the sectional plane and the oblique alignment of the lamellae, a plurality of lamellae are intersected. In contrast to the lamella arrangement in accordance with FIG. 1, the air flow is only minimally deflected by the lamellae 9. The air flows in the free cross sections between the lamellae 9 from a broadly vertical direction of inflow, deflected into a broadly horizontal direction of outflow along the lamellae 9. The deflection is essentially effected by the side walls and the drainage bottom 4 of the deflection chamber. Given that the lamellae 9 do not obstruct the flow cross section, further construction space can be saved in this arrangement, since, above the lamellae 9, no free flow cross section has to be kept free. In the edge region of the lamellae 9, a drainage profile 12 is mounted on their wall surface. This can jut out from the lamella, for example as a small protruding wall. On the drainage profile 12, droplets transported by the air skirting the lamella run off downward on the edge of the lamella facing the outlet port 3, before they can be entrained.

The illustrative embodiments represented in the figures can be realized, including in combination, in a construction space.

1.-9. (canceled)

10. A deflection chamber of a fresh air supply system of a motor vehicle, comprising:
an inlet port,
an outlet port,
at least one drainage wall for collection and evacuation of water, a direction of arrival of water droplets being directed from the inlet port toward the drainage wall, and
trapping elements for evacuation of water disposed in a free cross section between the inlet port and the drainage wall with surfaces thereof facing the inlet port which are aligned at an acute angle with respect to the direction of arrival,
wherein the trapping elements, from a perspective of the direction of arrival, cover the drainage wall, at least in a region disposed behind the inlet port in the direction of arrival.

11. The deflection chamber as claimed in claim 10, wherein the inlet port, in a mounted state, is disposed at a high level and the outlet port is disposed in a side wall of the deflection chamber, and wherein the drainage wall essentially comprises a wall region situated in the deflection chamber at least one of opposite and below the inlet port.

12. The deflection chamber as claimed in claim 10, wherein the trapping elements are configured as lamellae.

13. The deflection chamber as claimed in claim 12, wherein the lamellae are bent or curved along the direction of arrival.

14. The deflection chamber as claimed in claim 10, wherein the trapping elements are configured as wedge profiles.

15. The deflection chamber as claimed in claim 13, wherein two grilles, disposed one above the other in a mounted state and formed of approximately parallel-standing trapping elements, are disposed offset in such a way that an upper grille of the two grilles covers the drainage wall between the trapping elements, which are of a lower grille of the two grilles.

16. The deflection chamber as claimed in claim 10, wherein the trapping elements are aligned essentially transversely to a direction of outflow.

17. The deflection chamber as claimed in claim 10, wherein the trapping elements, at least in an upper region, are aligned approximately parallel to a direction of outflow.

18. The deflection chamber as claimed in claim 10, wherein drainage ribs for evacuation of water are disposed respectively on both sides, on surfaces of the lamellae, along an edge which limits a respective lamella in a direction of the outlet port.

19. The deflection chamber as claimed in claim 11, wherein the trapping elements are configured as lamellae.

20. The deflection chamber as claimed in claim 19, wherein the lamellae are bent or curved along the direction of arrival.

21. The deflection chamber as claimed in claim 11, wherein the trapping elements are configured as wedge profiles.

22. The deflection chamber as claimed in claim 11, wherein the trapping elements are aligned essentially transversely to a direction of outflow.

23. The deflection chamber as claimed in claim 12, wherein the trapping elements are aligned essentially transversely to a direction of outflow.

24. The deflection chamber as claimed in claim 13, wherein the trapping elements are aligned essentially transversely to a direction of outflow.

25. The deflection chamber as claimed in claim 14, wherein the trapping elements are aligned essentially transversely to a direction of outflow.

26. The deflection chamber as claimed in claim 11, wherein the trapping elements, at least in an upper region, are aligned approximately parallel to a direction of outflow.

27. The deflection chamber as claimed in claim 12, wherein the trapping elements, at least in an upper region, are aligned approximately parallel to a direction of outflow.

28. The deflection chamber as claimed in claim 13, wherein the trapping elements, at least in an upper region, are aligned approximately parallel to a direction of outflow.

29. The deflection chamber as claimed in claim 14, wherein the trapping elements, at least in an upper region, are aligned approximately parallel to a direction of outflow.
